(19) United States
(12) Patent Application Publication
(10) Pub. No.: US 2011/0141011 A1
(43) Pub. Date: Jun. 16, 2011

(54) METHOD OF PERFORMING A GAZE-BASED INTERACTION BETWEEN A USER AND AN INTERACTIVE DISPLAY SYSTEM

(75) Inventors: Tatiana Aleksandrovna Lashina, Eindhoven (NL); Evert Jan Van Loenen, Waalre (NL); Anthonie Hendrik Bergman, Nuenen (NL)

(73) Assignee: KONINKLIJKE PHILIPS ELECTRONICS N.V., EINDHOVEN (NL)

(21) Appl. No.: 13/060,441

(22) PCT Filed: Aug. 31, 2009
(86) PCT No.: PCT/IB09/53784

§ 371 Date: Feb. 24, 2011

(30) Foreign Application Priority Data
Sep. 3, 2008 (EP) 08105213.6

(51) Int. Cl. G06F 3/01

(52) U.S. Cl. 345/156

(57) ABSTRACT

The invention describes a method of performing a gaze-based interaction between a user (1) and an interactive display system (2) comprising a three-dimensional display area (D) in which a number of physical objects (10, 11, 12, 13, 14, 15, 16) is arranged, and an observation means (3), which method comprises the steps of acquiring a gaze-related output (30) for the user (1) from the observation means (3), determining a momentary gaze category (Gₒ, G_{dw}, G_{bo}, Gₙᵣ) from a plurality of gaze categories (Gₒ, G_{dw}, _{G}_{bo}, Gₙᵣ) on the basis of the gaze-related output (30); and continuously generating display area feedback according to the momentary determined gaze category (Gₒ, G_{dw}, G_{bo}, Gₙᵣ). The invention further describes an interactive display system (2) comprising a three-dimensional display area (D) in which a number of physical objects (10, 11, 12, 13, 14, 15, 16) is arranged, an observation means (3) for acquiring a gaze-related output (30) for a user (1), a gaze category determination unit (22) for determining a momentary gaze category (Gₒ, G_{dw}, G_{bo}, Gₙᵣ) from a plurality of gaze categories (Gₒ, G_{dw}, _{G}_{bo}, Gₙᵣ) on the basis of the gaze-related output (30); and a feedback generation unit (25) for continuously generating display area feedback (29) according to the momentary determined gaze category (Gₒ, G_{dw}, G_{bo}, Gₙᵣ).

### FIELD OF THE INVENTION

The invention describes a method of performing a gaze-based interaction between a user and an interactive display system. The invention also describes an interactive display system.

### BACKGROUND OF THE INVENTION

In recent years, developments have been made in the field of interactive shop window displays, which are capable of presenting product-related information using, for example, advanced projection techniques, with the aim of making browsing or shopping more interesting and attractive to potential customers. Presenting products and product-related information in this way contributes to a more interesting shopping experience. An advantage for the shop owner is that the display area is not limited to a number of physical items that must be replaced or arranged on a regular basis, but can display ‘virtual’ items using the projection and display technology now available. Such an interactive shop window can present information about the product or products that specifically interest a potential customer. In this way, the customer might be more likely to enter the shop and purchase the item of interest. Such display systems are also becoming more interesting in exhibitions or museums, since more information can be presented than would be possible using printed labels or cards for each item in a display case.

An interactive shop window system can detect when a person is standing in front of the window, and cameras are used to track the motion of the person's eyes. Techniques of gaze-tracking are applied to determine where the person is looking, i.e. the ‘gaze heading’, so that specific information can be presented to him. A suitable response of the interactive shop window system can be to present the person with more detailed information about that object, for example the price, any technical details, special offers, etc.

Since the field of interactive shop window systems is a very new one, such shop windows are relatively rare, so that most people will not be aware of their existence, or cannot tell whether a shop window is of the traditional, inactive kind, or of the newer, interactive kind. Gaze tracking is very new to the general public as a means of interacting, presenting the challenge of how to communicate to a person that a system can be controlled by means of gaze. This is especially relevant for interactive systems in public spaces, such as shopping areas, museums, galleries, amusement parks, etc., where interactive systems must be intuitive and simple to user, so that anyone can interact with them without having to first consult a manual or to undergo training.

As already indicated, such systems can only work if the person's gaze can actually be detected. Usually, in state of the art systems, a person only receives feedback when a gaze vector is detected within a defined region associated with an object in the display area. In other words, feedback is only given to the person when he or she is specifically looking at an object. When the person is looking at a point between objects in the display area, or during a gaze saccade, feedback is not given, so that the status of the interactive system is unknown to the person. State of the art gaze tracking does not deliver a highly robust detection of user input. Furthermore, the accuracy of detection of the user's gaze can be worsened by varying lighting conditions, by the user changing his position in front of the cameras, or by changing the position of his head relative to the cameras focus, etc. Such difficulties in determining gaze detection in state of the art interactive systems can lead to situations when there is either no feedback to the user on the system status, for instance when the system has lost the track of gaze; or the object most recently looked at remains highlighted even when the user is already looking somewhere else. Such behaviour can irritate a user or potential customer, which is evidently undesirable.

Therefore, it is an object of the invention to provide a way of communicating to a user the capabilities of an interactive display system to avoid the problems mentioned above.

### SUMMARY OF THE INVENTION

The object of the invention is achieved by the method of performing a gaze-based interaction between a user and an interactive display system according to claim 1, and an interactive display system according to claim 10.

The method of performing a gaze-based interaction between a user and an interactive display system comprising a three-dimensional display area in which a number of physical objects is arranged and an observation means comprises the steps of acquiring a gaze-related output for the user from the observation means; determining a momentary gaze category from a plurality of gaze categories on the basis of the gaze-related output; and continuously generating display area feedback according to the momentary determined gaze category.

The proposed solution is applicable for public displays offering gaze-based interaction, such as interactive shop windows, interactive exhibitions, museum interactive exhibits, etc.

An advantage of the method according to the invention over state of the art techniques is that display area feedback about the gaze detection status of the system is continuously provided, so that a user is constantly informed about the status of the interactive display system. In other words, the user does not have to first intentionally or unintentionally look at an object, item or product in the display area to be provided with feedback, rather the user is given feedback all the time, even if an object in the display area is not looked at. Advantageously, a person new to this type of interactive display system is intuitively provided with an indication of what the display area is capable of, i.e. feedback indicating that this shop window is capable of gaze-based interaction. The user need only glance into the display area to be given an indication of the gaze detection status. In effect, for a user in front of the display area, there is no time in which the user is not informed or is not aware of the system status, so that the can choose to react accordingly, for example by looking more directly at an object that interests him.

Here, a ‘gaze-related output’ means any information output by the observation means relating to a potential gaze. For instance, if a user's head can be detected by the observation means, and his eyes can be tracked, the gaze-related output of the observation means can be used to determine the point at which he is looking.

An interactive display system according to the invention comprises a three-dimensional display area in which a number of physical objects is arranged, an observation means for acquiring a gaze-related output for a user, a gaze category determination unit for determining a momentary gaze category from a plurality of gaze categories on the basis of the gaze-related output, and a feedback generation unit for continuously generating display area feedback according to the momentary determined gaze category.

The system according to the invention provides an intuitive means for letting a user know that he can easily interact with the display area, allowing a natural and untrained behaviour essential for public interactive displays for which it is neither desirable nor practicable to have to train users.

The dependent claims and the subsequent description disclose particularly advantageous embodiments and features of the invention.

As already indicated, the interactive display system and the method of performing a gaze based interaction described by the invention are suitable for application in any appropriate environment, such as an interactive shop window in a shopping area, inside a shop for automatic product presentation at the POP (point of purchase), in an interactive display case in an exhibition, trade fair or museum environment, etc. In the following, without restricting the invention in any way, the display area may be assumed to be a shop window. Also, a person who might interact with the system is referred to in the following as a ‘user’. The contents of the display area being presented can be referred to below as ‘items’, ‘objects’ or ‘products’, without restricting the invention in any way.

The interactive display system according to the invention can comprise a detection module for detecting the presence of a user in front of the display area, such as one or more pressure sensors in the ground in front of the display area, any appropriate motion sensor, or a an infra-red sensor. Naturally, the observation means itself could be used to detect the presence of a user in front of the display area.

The observation means can comprise an arrangement of cameras, for example a number of moveable cameras mounted inside the display area. A observation means designed to track the movement of a person's head is generally referred to as a ‘head tracker’. Some systems can track the eyes in a person's face, for example a ‘Smart Eye®’, tracking device, to deliver a gaze-related output, i.e. information describing the estimated direction in which the user's eyes are looking. Provided that the observation means can detect the eyes of the user, the direction of looking, or gaze direction, can be deduced by the application of known algorithms. Since the display area is a three-dimensional area, and the positions of objects in the display area can be described by co-ordinates in a co-ordinate system, it would be advantageous to describe the gaze direction by, for example, a head pose vector for such a co-ordinate system. The three dimensions constituting a head pose vector are referred to as yaw or heading (horizontal rotation), pitch (vertical rotation) and roll (tilting the head from side to side). Not all of this information is required to determine the point at which the user is looking. A vector describing the direction of looking can include relevant information such as only the heading, or the heading together with the pitch, and is referred to as the ‘gaze heading’. Therefore, in a particularly preferred embodiment of the invention, the gaze-related output is translated into a valid gaze heading for the user provided that the gaze direction of that user can be determined from the gaze-related output. In the case where no user is detected in front of the display area, or if a user is there but his eyes cannot be tracked, the algorithm or program that processes the data obtained by the observation means can simply deliver an invalid, empty or ‘null’ vector to indicate this situation.

Since feedback is to be provided continually, the gaze output and gaze heading are analyzed to determine the type of feedback to be provided. In the method according to the invention, feedback is supplied according to the momentary gaze category. Therefore, in a further particularly preferred embodiment of the invention, the gaze category or class can be determined according to one of the following four conditions:

1) In a first gaze category, the gaze heading is directed at an object in the display area for less than a predefined dwell-time, for instance when the user just looks briefly at an object and then looks elsewhere. This can correspond to an “object looked at” gaze category.
2) In a second gaze category, the gaze heading is directed at an object in the display area for at least a predefined dwell-time. This would indicate that the user is actually interested in this particular object, and might be associated with a “dwell time exceeded for object” category.
3) In a third gaze category, the gaze heading is directed between objects in the display area. This situation could arise when, for example, a user is looking into the display area, but is not aware that he can interact with the display area using gaze alone. The user's gaze may also be directed briefly away from an object at which he is looking during what is known as a gaze saccade. A “between objects” gaze category might be assigned here.
4) In a fourth gaze category, the gaze heading cannot be determined from the gaze-related output. This can be because a user in front of the display area is looking in a direction such that the observation means cannot track one or both of his eyes. This can correspond to a “null” gaze category. This category could also apply to a situation where there is no user detected, but the display area contents are to be visually emphasised in some way, for instance with the aim of attracting potential customers to approach the shop window.

Here and in the following, the descriptive titles for the gaze categories listed above are exemplary titles only, and are simply intended to make the interpretation of the different gaze categories clearer. In a program or algorithm, the gaze categories might be given any suitable identifier or tag, as appropriate.

Once the momentary gaze category has been determined, the display area can be controlled to reflect this gaze category. In a preferred embodiment of the invention, an object in the display area, or a point in the display area, is selected for visual emphasis on the basis of the momentary gaze category, and the step of generating display area feedback comprises controlling the display area to visually emphasise the selected object or to visually indicate the point being looked at, according to this momentary gaze category. The different ways of visually emphasising an object or objects in the display area are described in the following.

In one preferred embodiment of the invention, should the user look directly at an object, the first or second gaze categories apply, and generating display area feedback according to the momentary gaze category can involve visually emphasising the looked at object. For example, if the display area is equipped with an array of moveable spotlights, such as an array of Fresnel lenses, these can be controlled to direct their light beams at the identified object. For instance, if the user briefly looks at a number of objects in turn, these are successively highlighted, and the user can realise that the system is reacting to his gaze direction. Visual emphasis of an object can involve highlighting the object using spotlights as mentioned above, or can involve projecting an image on or behind the object so that this object is visually distinguished from the other objects in the display area.

An object that interests the user will generally hold the user's gaze for a longer period of time. In the method according to the invention, a minimum dwell-time can be defined, for example a duration of two seconds. Should a user look at an object for at least this long, it can assume that he is interested in the object, so that the momentary (second) gaze category is “dwell time exceeded”, and the system can control the display area accordingly. Generating display area feedback according to the momentary “dwell time exceeded” gaze category can comprise, for example, projecting an animated ‘aura’ or ‘halo’ about the object of interest, increasing the intensity of a spotlight directed at that object, or narrowing the combined beams of a number of spotlights focussed on that object. In this further preferred embodiment, the system is ‘letting the user know’ that it has identified the object in which the user is interested. The highlighting of the selected object can become more intense the longer the user is looking at that object, so that this type of feedback can have an affirmative effect, letting the user know that the system is responding to his gaze. In response to the user's interest, product-related information such as, for example price, available sizes, available colours, name of a designer etc., can be projected close by that item. When the user's gaze moves away from that object, the information can fade out after a suitable length of time.

Naturally, it is conceivable that product related information could be supplied whenever the user looks at an object, however briefly, without distinguishing between an “object looked at” gaze category and a “dwell time exceeded” gaze category. However, showing product information every time a user glances at an object could be too cluttered and too confusing for the user, so that it is preferable to distinguish between these categories, as described above.

In another preferred embodiment of the invention, when the gaze output and gaze heading indicate that the user is indeed looking into the display area, but between objects in the display area, such that the third gaze category, “between objects”, applies, the step of generating feedback can comprise controlling the display area to show the user that his gaze is being registered by the system. To this end, a visual feedback can be shown at the point at which the user's gaze is directed. With appropriate known algorithms, it is relatively straightforward to determine the point at which the gaze heading is directed. The visual feedback in this case can involve, for instance, showing a static or animated image at the point looked at by the user, for example by rendering an image of a pair of eyes that follow the motion of the user's eyes, or an image of twinkling stars that move in the direction in which the user moves his eyes. Alternatively, one or more spotlights can be directed at the point at which the user is looking, and can be controlled to move according to the eye movement of the user. Since the image or highlighting follows the motion of the user's eyes, it can be referred to as a ‘gaze cursor’. This type of display area feedback can be particularly helpful to a user new to this type of interactive system, since it can indicate to him that he can use his gaze to interact with the system.

The capabilities of an interactive display area need not be limited to simple highlighting of objects. With modern rendering techniques it is possible, for example, to present information to the user by availing of a projection system to project an image or sequence of images on a screen, for example a screen behind the objects arranged in the display area. Therefore, in another embodiment of the inception, visual emphasis of an item in the display area can comprise the presentation of item-related information. For example, for products in a shop window, the system can show information about the product such as designer name, price, available sizes, or can show the same product as it appears in a different colour. For an item of clothing, the system could show a short video of that item being worn by a model. In an exhibition environment, such as a museum with items displayed in showcases, the system can render information in one or more languages describing the item that the user is looking at. The amount of information shown can, as already indicated, be linked to the momentary gaze category determined according to the user's gaze behaviour.

As mentioned above, a user might be detected in front of the display area, but the observation means may fail to determine a gaze heading, for instance if the user is looking too far to one side of the display area. Such a situation might result in allocation of a “null” gaze category. In such a case the step of generating display area feedback according to the fourth gaze category comprises controlling the display area to visually indicate that a gaze heading has not been obtained. For example, a text message could be displayed saying that gaze output cannot be determined, or, in a more subtle approach, each of the objects in the display area could be highlighted in turn, showing their pertinent information. If the display area is equipped with moveable spotlights, these could be driven to sweep over and back to that the objects in the display area are illuminated in a random or controlled manner. Alternatively, the display area feedback can involve, for instance, showing some kind of visual image reflecting the fact that the user's gaze cannot be determined, for example a pair of closed eyes ‘drifting’ about the display area, a puzzled face, a question mark, etc., to indicate that ‘the gaze is off’. Should the user react, i.e., should the user look into the display area such that the observation means can determine a gaze heading, the pair of eyes can ‘open’ and follow the motion of the user's eyes. Feedback in the case of failed gaze tracking could also be given as an audio output message. In another approach when gaze tracking fails, the system can simulate gaze input, generating fixation points and saccades, thus modelling a natural gaze path and generating feedback accordingly. Alternatively, as soon as gaze tracking has failed the system could start a pre-recorded multimedia presentation of the objects in the scene, e.g. it would highlight objects of the scene one-by-one and display related content. This approach does not require any understanding from the user of what is happening and is in essence another way of displaying product-related content without user interaction.

Naturally, the method according to the invention is not limited to the gaze categories described here. Other suitable categories could be used. For example, in the case where the gaze output indicates that there is nobody in front of the display area, the system might apply a “standby” gaze category, in which no highlighting is performed. This might be suitable in a museum environment. Alternatively, this “standby” type of category might involve highlighting each of the objects in turn, in order to attract potential users, for example in a shopping mall or trade fair environment, where it can be expected that people would pass in front of the display area.

The interactive display system according to the invention can comprise a controllable or moveable spotlight which can be controlled, for example electronically, to highlight a looked-at object in the display area. In such an embodiment, the feedback generation unit can comprise a control unit realised to control the spotlight to render the display area feedback For example, the control unit can issue signals to change the direction in which the spotlight is aimed, as well as signals to control its colour or intensity. However, a display area might, for whatever reason, be limited to an arrangement of shelves upon which objects can be placed for presentation, or a shop window might be limited to a wide but shallow area. Using a single spotlight, it may be difficult to accurately highlight an object in the presentation area. Therefore, one embodiment of the interactive display system according to the invention preferably comprises an arrangement of synchronously operable spotlights for highlighting an object in the display area. Such spotlights could be arranged inconspicuously on the underside of shelving. As mentioned above, such spotlights could comprise Fresnel lenses or LC (liquid crystal) lenses that can produce a moving beam of light according to the voltage applied to the spotlight. Preferably, several such spotlights can be synchronously controlled, for example in motion, intensity and colour, so that one object can be highlighted to distinguish it from other objects in the display area, in a particularly simple and effective manner. In the case that the user is looking between objects, one or more spots could be controlled such that their beams of light converge at the point looked at by the user, and to follow the motion of the user's eyes. If no gaze heading can be detected, the spots can be controlled to illuminate the objects successively. Should a user's gaze be detected to rest on one of the objects, several beams of light can converge on this object while the remaining objects are not illuminated, so that the object being looked at is highlighted for the user. Should he look at this object for longer than a certain dwell-time, the beams of light can become narrower and maybe also more intense, signalling to the user that his interest has been noted. The advantage of such a feedback is that it is relatively economical to realise, since most shop windows are equipped with lighting fixtures, and the control of the spots described here is quite straightforward.

In a somewhat more sophisticated embodiment, an interactive display system according to the invention can comprise a micro-stepping motor-controllable laser to project images into the display area. Such a device could be located in the front of the display area so that it can project images or lighting effects onto any of the objects in the display area, or between objects in the display area.

Alternatively, a steerable projector could be used to project an image into the display area. Since projection methods allow detailed product information to be shown to the user, a particularly preferred embodiment of the interactive display system comprises a screen behind the display area, for example a rear projection screen. Such a projection screen is preferably controlled according to an output of the feedback generation unit, which can supply it with appropriate commands according to the momentary gaze category, such as commands to present product information for a “dwell-time exceeded” gaze category, or commands to project an image of a pair of eyes for a “between objects” category. In one possible realization, the projection screen can be positioned behind the objects in the display area. In another possible realization, the projection screen can be an electrophoretic display with different modes of transmission, for example ranging from opaque through semi-transparent to transparent. More preferably, the projection screen can comprise a low-cost passive matrix electrophoretic display. These types of electrophoretic screens can be positioned between the user and the display area. A user may either look through such a display at an object behind it when the display is in a transparent mode, read information that appears on the display for an object that is, at the same time, visible through the display in a semi-transparent mode, or see only images projected onto the display when the display is in an opaque mode. Naturally, a screen need not be a projection screen, but can be any suitable type of surface upon which images or highlighting effects can be rendered, for example a liquid crystal display or a TFT (thin-film transistor) display.

The interactive display system according to the invention preferably comprises a database or memory unit for storing position-related information for the objects in the display area, so that a gaze heading determined for a valid gaze output can be associated with an object, for example the object closest to a point at which the user is looking, or an object at which the user is looking. For a system which is capable of rendering images on a screen in the display area, such a database or memory preferably also stores product-related information for the objects, so that the feedback generation unit can be supplied with appropriate commands and data for rendering such information to give an informative visual emphasis of a product being looked at by the user.

So that the feedback generation unit can be used to control the display area correctly, it is necessary to ‘link’ the objects in the display area to the object-related content, and to store this information in the database. This could be achieved, for example, using RFID (radio frequency identification) readers embedded into the shelves to detect RFID tags embedded or attached to the objects for the purpose of identification. The system can then constantly track the objects' positions and retrieve object-relevant content according to gaze category and gaze heading. Using RFID identification the system can update the objects' positions whenever arrangement of objects is altered.

Alternatively, objects in the display area could be identified by means of image recognition. Particularly in the case of a projection screen placed behind the objects and used to highlight the objects by giving them a visible ‘aura’, the actual shapes or contours of the objects need to be known to the system. There are several ways of detecting a contour automatically. For example, a first approach involves a one-time calibration that needs to be done whenever the arrangement of products is altered, e.g. one product is replaced by another. To commence the calibration, a distinct background is displayed on the screen behind the products. The camera takes a snapshot of the scene and extracts the contours of the objects by subtracting the known background from the image. Another approach uses the TouchLight touch screen in a vision-based solution that makes use two cameras behind a transparent screen to detect the contours of touching or nearby objects.

Other objects and features of the present invention will become apparent from the following detailed descriptions considered in conjunction with the accompanying drawings. It is to be understood, however, that the drawings are designed solely for the purposes of illustration and not as a definition of the limits of the invention.

### BRIEF DESCRIPTION OF THE DRAWINGS

FIG. 1 shows a schematic illustration of a user and an interactive display system according to an embodiment of the invention;

FIG. 2a shows a schematic front view of a display area with feedback being provided using a method according to the invention for a point between objects being looked at;

FIG. 2b shows a schematic front view of a display area with feedback being provided using a method according to the invention for an object being looked at;

FIG. 2c shows a schematic front view of a display area with feedback being provided using a method according to the invention for an object being looked at for a predefined dwell time;

FIG. 3a shows a schematic front view of a display area with feedback being provided using a method according to the invention for an object being looked at;

FIG. 3b shows a schematic front view of a display area with feedback being provided using a method according to the invention for a point between objects being looked at.

In the drawings, like numbers refer to like objects throughout. Objects in the diagrams are not necessarily drawn to scale.

### DETAILED DESCRIPTION OF THE EMBODIMENTS

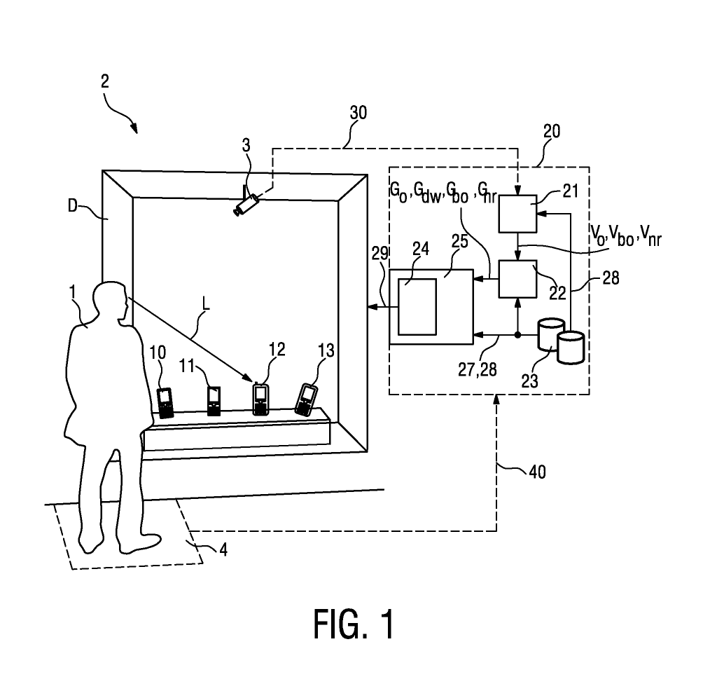

FIG. 1 shows a user 1 in front of a display area D, in this case a potential customer 1 in front of a shop window D. For the sake of clarity, this schematic representation has been kept very simple. In the shop window D, items 10, 11, 12, 13 are arranged for display, in this example different mobile telephones 10, 11, 12, 13. A detection means 4, in this case a pressure mat 4, is located at a suitable position in front of the shop window D so that the presence of a potential customer 1 who pauses in front of the shop window D can be detected. A head tracking means 3 with a camera arrangement is positioned in the display area D such that the head motion of the user 1 can be tracked as the user 1 looks into the display area D. The head tracking means 3 can be activated in response to a signal 40 from the detection means 4 delivered to a control unit 20. Evidently, such a detection means 4 is not necessarily required, since the observation means 3 could also be used to detect the presence of the user 1. However, use of a pressure mat 4 or similar can trigger the function of the observation means 3, which could otherwise be placed in an inactive or standby mode, thus saving energy when there is nobody in front of the display area D.

The control unit 20 will generally be invisible to the user 1, and is therefore indicated by the dotted lines. The control unit 20 is shown to comprise a gaze output processing unit 21 to process the gaze output data 30 supplied by the head tracker 3, which can monitor the movements of the user's head and/or eyes. A database 23 or memory 23 stores information 28 describing the positions of the items 10, 11, 12, 13 in the display area D, and also stores information 27 to be rendered to the user when an object is selected, for example product details such as price, manufacturer, special offers, descriptive information about other versions of this object, etc.

If the gaze output processing unit 21 determines that the user's gaze direction is directed into the display area D, the gaze output 30 is translated into a valid gaze heading Vₒ, V_{bo}. Otherwise, the gaze output 30 is translated into a null-value gaze heading Vₙᵣ, which may simply be a null vector. Evidently, the output of the gaze output processing unit 21 need only be a single output, and the different gaze headings Vₒ, V_{bo}, Vₙᵣ shown here are simply illustrative.

When the user's gaze L is directed at an object, the gaze heading would ‘intercept’ the position of the object in the display area. For example, as shown in the diagram, the user 1 is looking at the object 12. The resulting gaze heading Vₒ is determined by the gaze output processing unit 21 using co-ordinate information 28 for the objects 10, 11, 12, 13 stored in the database 23, to determine the actual object 12 being looked at. If the user 1 looks between objects, this is determined by the gaze output processing unit 21, which cannot match the valid gaze heading V_{bo} to the co-ordinates of an object in the display area D.

In a following gaze category determination unit 22, a momentary gaze category Gₒ, G_{dw}, G_{bo}, Gₙᵣ is determined for the current gaze heading Vₒ, V_{bo}, Vₙᵣ, again with the aid of the position information 28 for the items 10, 11, 12, 13 supplied by the database 23. For example, when the user 1 is looking at an object and that object has been identified by its co-ordinates, the momentary gaze category Gₒ can be classified as “object looked at”, in which case that object can be highlighted as will be explained below. Should the user fixate this object, i.e. look at it steadily for a predefined dwell time, the momentary gaze category G_{dw} can be classified as “dwell time exceeded for object”, in which case detailed product information for that object is shown to the user, as will be explained below. For the case that the user is looking between objects, the momentary gaze category G_{bo} can be classified as “between objects”. If the observation means cannot track the user's eyes, the resulting null vector causes the gaze category determination unit 22 to assign the momentary gaze category Gₙᵣ with an interpretation of “null”. Here, for the purposes of illustration, the gaze category determination unit 22 is shown as a separate entity to the gaze output processing unit 21, but these could evidently be realised as a single unit.

The momentary gaze category Gₒ, G_{dw}, G_{bo}, Gₙᵣ is forwarded to a feedback generation unit 25, along with product-related information 27 and co-ordinate information 28 from the database 23 pertaining to any object being looked at by the user 1 (for a valid gaze heading Vₒ) or an object close to the point at which the user 1 is looking (for a valid gaze heading V_{bo}). A display controller 24 generates commands 29 to drive elements of the display area D, not shown in the diagram, such as a spotlight, a motor, a projector, etc., to produce the desired and appropriate visual emphasis so that the user is continually provided with feedback pertaining to his gaze behaviour.

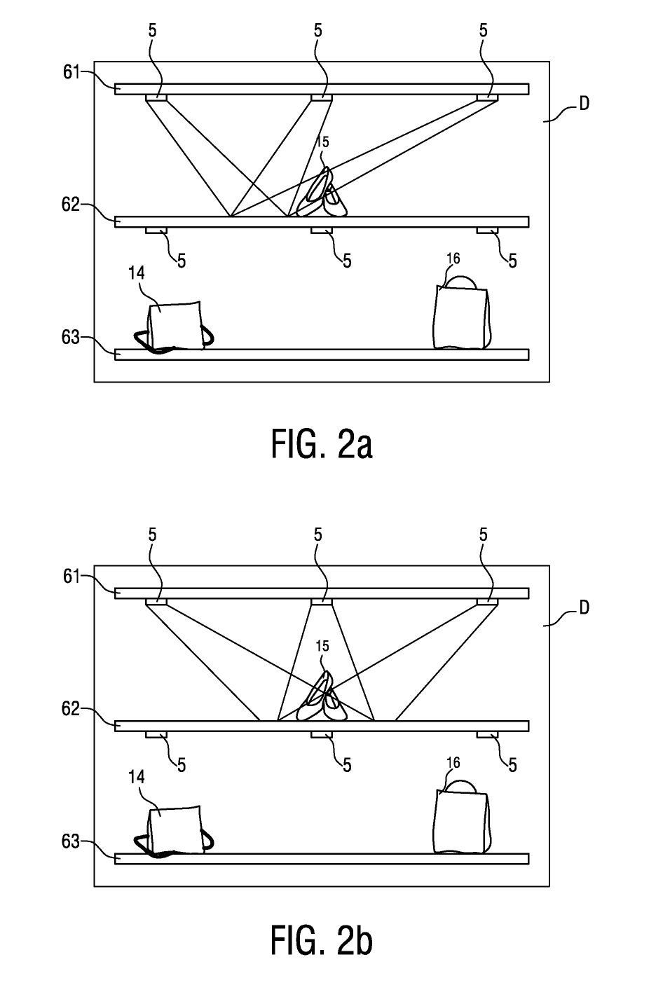

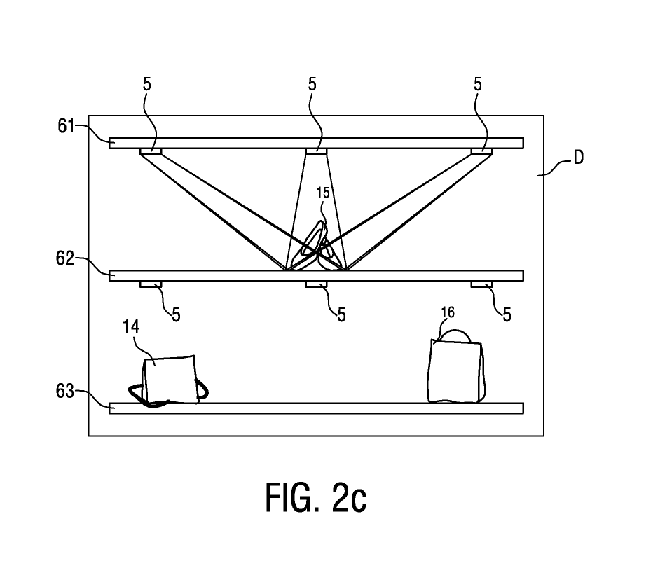

A basic embodiment of an interactive system according to the invention is shown with the aid of FIGS. 2a-2c which show a schematic front view of a display area D. For the sake of simplicity, the observation means and control unit are not shown here, but are assumed to be part of the interactive system as described with FIG. 1 above.

A lighting arrangement comprising synchronously controllable Fresnel spotlights 5 is shown, in which the spotlights 5 are mounted on the underside of shelves 61, 62 such that objects 14, 15, 16 on the lower shelves 62, 63 can be illuminated. FIG. 5 shows how feedback can be given to a user (not shown) when he looks into the display area D. Let us assume that the user has paused in front of the display area D and his gaze is moving over an area to the left of the shoes 15 on the middle shelf 62. The point at which he is looking at is determined in the control unit, which issues commands signals to the spots 5 so that the spotlights under the upper shelf 61, so that the beams of light issuing from these spots 5 converge at that point. As the user moves his eyes to look across the display area, the spots are controlled so that the converged beams ‘follow’ the motion of his eyes. In this way, the user knows immediately that the system reacts to his gaze, and that he can control the interaction with his gaze.

Should the user look at the shoes 15 on the middle shelf 62, the control unit identifies this object 15 and controls the spots 5 on the upper shelf to converge over the shoes 15 such that these are illuminated or highlighted, as shown in FIG. 2b. If the shoes 15 are of interest to the user, his gaze may dwell on the shoes 15, in which case the system reacts to control the spots 5 on the upper shelf 61 so that the beam of light narrows, as shown in FIG. 2c.

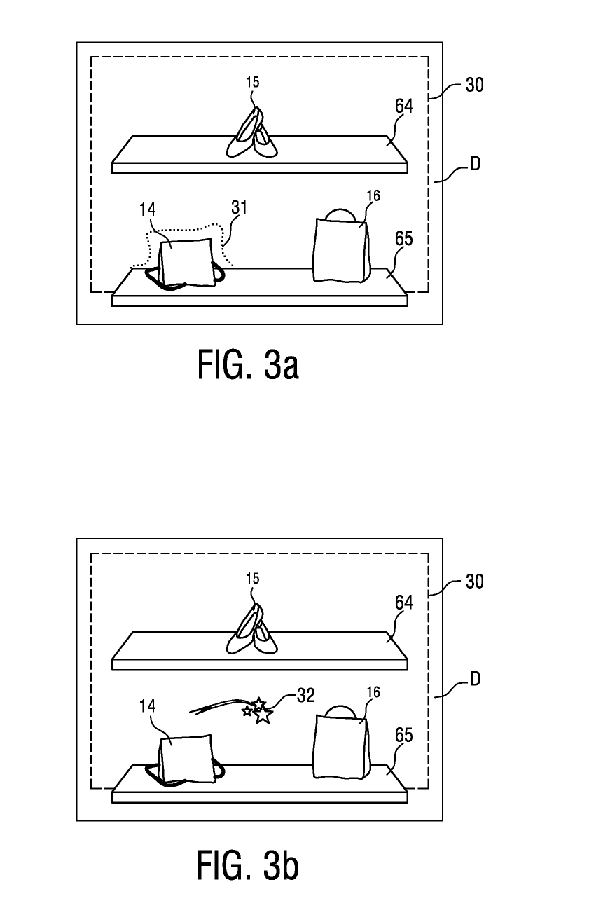

A more sophisticated embodiment of an interactive display system is shown in FIGS. 3a and 3b, again without the control unit or observation means, although these are assumed to be included. In this embodiment, the display area D also includes a projection screen 30 positioned behind the objects 14, 15, 16 arranged on shelves 64, 65. Images can be projected onto the screen 30 using a projection module which is not shown in the diagram.

FIG. 3a shows feedback being provided for an object 14, in this case a bag 14, being looked at. Knowledge of the shape of the bag is stored in the database of the control unit, so that, when the gaze output processing unit determines that this bag 14 is being looked at, its shape is emphasised by a bright outline 31 or halo 31 projected onto the screen 30. If the user looks at the bag 14 for a time longer than a predefined dwell time, additional product information for this bag 14, such as information about the designer, alternative colours, details about the materials used, etc., can be projected onto the screen 30. In this way, the display area can be kept ‘uncluttered’, while any necessary information about any of the objects 14, 15, 16 can be shown to the user if he is interested.

This embodiment of the system according to the invention can be used to very intuitively show a user that he can use his gaze to interact with the system. FIG. 3b shows a situation in which the user's gaze is between objects, for example if the user is glancing into the shop window D while passing by. His gaze is detected, and the point at which he is looking is determined. At a point on the screen 30 that would be intersected by his gaze, a gaze cursor 32 is projected. In this case, the gaze cursor 32 shows an image of a shooting star that ‘moves’ in the same direction as the user's gaze, so that he can comprehend instantly that his gaze is being tracked and that he can interact with the system using his gaze.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. A “unit” or “module” can comprise a number of units or modules, unless otherwise stated.

1-14. (canceled)

15. A method of performing a gaze-based interaction between a user and an interactive display system comprising a three-dimensional display area in which a number of physical objects is arranged, and an observation means, the method comprising the steps of:
acquiring a gaze-related output for the user by the observation means;
translating the gaze-related output into a gaze heading for the user based on a gaze direction of the user derived from the gaze-related output;
determining a momentary gaze category from a plurality of gaze categories based on the gaze-related output, wherein the momentary gaze category is selected from the group consisting of
a first gaze category when the gaze heading is directed at an object in the display area for less than a predefined dwell-time;
a second gaze category when the gaze heading is directed at an object in the display area for at least a predefined dwell-time;
a third gaze category when the gaze heading is directed between objects in the display area; and
continuously generating display area feedback according to the momentary determined gaze category.

16. A method according to claim 15, wherein the momentary gaze category is the first or second gaze category and wherein the step of generating display area feedback comprises controlling the display area (D) to visually emphasise the object at which the user's gaze is directed.

17. A method according to 16, wherein the momentary gaze category is the second gaze category and wherein the step of generating display area feedback according to the second gaze category comprises controlling the display area (D) to visually emphasise the selected object according to a dwell-time.

18. A method according to claim 16, wherein visually emphasising an object in the display area (D) comprises presenting object-related information to the user.

19. A method according to claim 15, wherein the momentary gaze category is the third gaze category and wherein the step of generating display area feedback according to the third gaze category comprises controlling the display area to visually emphasise the point at which the user's gaze is directed.

20. A method according to claim 15, wherein the step of generating display area feedback comprises rendering an image in the display area (D).

21. An interactive display system, comprising
a three-dimensional display area in which a number of physical objects is arranged;
an observation means for acquiring a gaze-related output for a user;
a gaze output processing unit for translating the gaze-related output into a gaze heading for the user based on a gaze direction of the user derived from the gaze-related output
a gaze category determination unit for determining a momentary gaze category from a plurality of gaze categories based on the gaze-related output; and
a feedback generation unit for continuously generating display area feedback according to the momentary determined gaze category.

22. An interactive display system according to claim 21, further comprising an arrangement of synchronously operable spotlights for highlighting an object in the display area, and wherein the feedback generation unit comprises a control unit configured to control the spotlights to render the display area feedback.

23. An interactive display system according to claim 21, further comprising a memory unit for storing position-related information for the objects in the display area.

24. An interactive display system according to claim 21, wherein the display area comprises a projection screen, and wherein the feedback generation unit comprises a control unit configured to control the projection screen to render the display area feedback.
